(19) United States
(12) Patent Application Publication
(10) Pub. No.: US 2026/0051780 A1
(43) Pub. Date: Feb. 19, 2026

(54) STATOR TOOTH INSULATOR ASSEMBLY

(71) Applicant: BorgWarner Inc., Auburn Hills, MI (US)

(72) Inventors: John R. Smerczak, Ortonville, MI (US); Anthony Mattord, Macomb Township, MI (US)

(21) Appl. No.: 18/806,846

(22) Filed: Aug. 16, 2024

(51) Int. Cl. H02K 3/52

(52) U.S. Cl. CPC H02K 3/522; H02K 2203/12

(57) ABSTRACT

A tooth insulator for use in a rotating electrical machine including a body, shaped to conform to an outer surface of a tooth; a first elongated leg, extending away from the body; a second elongated leg, extending away from the body; a deformable slot positioned between the first elongated leg and the second elongated leg, wherein the deformable slot permits temporary displacement of the first elongated leg relative to the second elongated leg to fit over an outer surface of the tooth and force exerted by the first elongated leg and the second elongated leg on the outer surface of the tooth when in situ.

### TECHNICAL FIELD

The present application relates to rotating electrical machines and, more particularly, to stator assemblies included with the rotating electrical machines.

### BACKGROUND

Rotating electrical machines can be formed in a variety of ways. Typically, they include a stator assembly having a substantially-cylindrically-shaped stator core and a plurality of radially inwardly extending stator slots configured to receive stator windings (sometimes referred to as field windings. The stator assembly can concentrically receive a rotor assembly comprising a rotor and a rotor shaft. The rotor can be implemented in different ways, such as bey having a plurality of permanent magnets angularly spaced around the rotor. The stator windings can receive electrical current that can angularly displace the rotor assembly with respect to the stator assembly. The stator assembly can include insulation between the stator core and the stator windings. However, the inclusion of the insulation as part of the manufacturing process can be challenging.

### SUMMARY

In one implementation, a tooth insulator for use in a rotating electrical machine includes a body, shaped to conform to an outer surface of a tooth; a first elongated leg, extending away from the body; a second elongated leg, extending away from the body; and a deformable slot positioned between the first elongated leg and the second elongated leg, wherein the deformable slot permits temporary displacement of the first elongated leg relative to the second elongated leg to fit over an outer surface of the tooth and force exerted by the first elongated leg and the second elongated leg on the outer surface of the tooth when in situ.

In another implementation, a tooth insulator for use in a rotating electrical machine includes a body, shaped to conform to an outer surface of a stator tooth; a first elongated leg, extending away from the body, having a tooth-gripping surface configured to abut an outer surface of the stator tooth; a second elongated leg, extending away from the body, having a tooth-gripping surface configured to abut the outer surface of the stator tooth; and a deformable slot positioned between the first elongated leg and the second elongated leg, wherein the first elongated leg is displaceable relative to the second elongated leg to fit over an outer surface of the stator tooth, and the first elongated leg and the second elongated leg press against the outer surface of the stator tooth in a default position.

### BRIEF DESCRIPTION OF THE DRAWINGS

FIG. 1 is a perspective view depicting an implementation of tooth insulators included on a stator core;

FIG. 2 is another perspective view depicting an implementation of tooth insulators included on a stator core;

FIG. 3 is a plan view depicting an implementation of tooth insulators included on a stator assembly;

FIG. 4 is a cross-sectional view depicting an implementation of tooth insulators included on a stator assembly;

FIG. 5 is another cross-sectional view depicting an implementation of tooth insulators included on a stator assembly;

FIG. 6 is a profile view depicting an implementation of a tooth insulator;

FIG. 7 is a perspective view depicting an implementation of a tooth insulator;

FIG. 8 is a perspective view depicting another implementation of a tooth insulator; and

FIG. 9 is a perspective view depicting yet another implementation of a tooth insulator.

### DETAILED DESCRIPTION

A rotating electrical machine, sometime called an electric motor, can include a stator assembly and a rotor assembly. The stator assembly can include a stator core having a plurality of stator teeth configured to receive tooth insulators and a stator housing that receives the stator core. Stator windings can be wound around the stator teeth over the tooth insulators such that the tooth insulators electrically insulate the stator core from the stator windings. The tooth insulators can be configured to grip the stator teeth while in a default, or installed position, such that the tooth insulators have a compliance slot that is elastically deformable so that elongated legs of the tooth insulators may be deflected away from each other in response to mechanical force so that the tooth insulators can slide over an outer surface of each stator tooth yet grip the outer surface of the stator tooth when the mechanical force is no longer applied to create the deflection. In some implementations, the stator core can be rollable so that in an initial state the stator core can be configured to extend along a substantially linear axis to provide addition space for combining the tooth insulator with the stator teeth and subsequently adding stator windings over the tooth insulators as they are fitted over the stator teeth. After adding the stator windings, the stator core can be rolled into a substantially circular shape. The rolled stator core can be placed into a position so that the stator core can be axially pressed into the stator housing. The mechanical force used to axially move the rolled stator core into the stator housing can be applied to planar surfaces formed on a radial face of the tooth insulators. The planar surfaces can be shaped and formed so as to accept a force sufficient to move the rolled stator core into a friction-fit engagement with the stator housing without meaningful deformation.

The rotor assembly can include a rotor having radially-inwardly-facing teeth. In some implementations, each rotor tooth can include a tooth insulator having a deformable slot permitting the tooth insulator to slide over the rotor tooth while the elongated legs were deflected away from each other in response to an external force yet grip an outer surface of the rotor tooth when the elongated legs were permitted to return to their default position. Rotor windings can be wound around the tooth insulator installed over the rotor tooth.

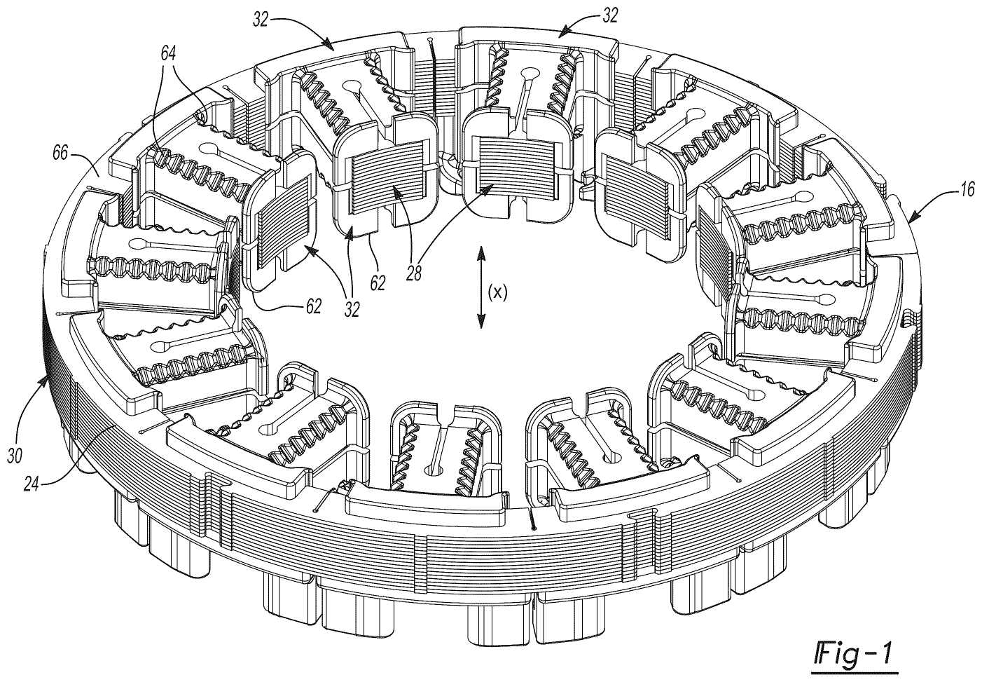

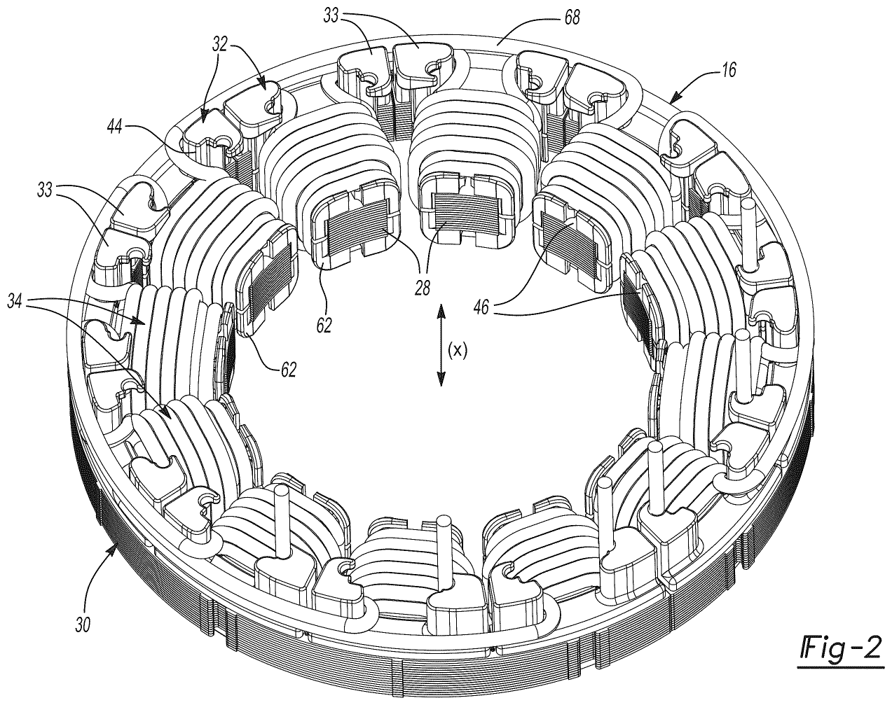

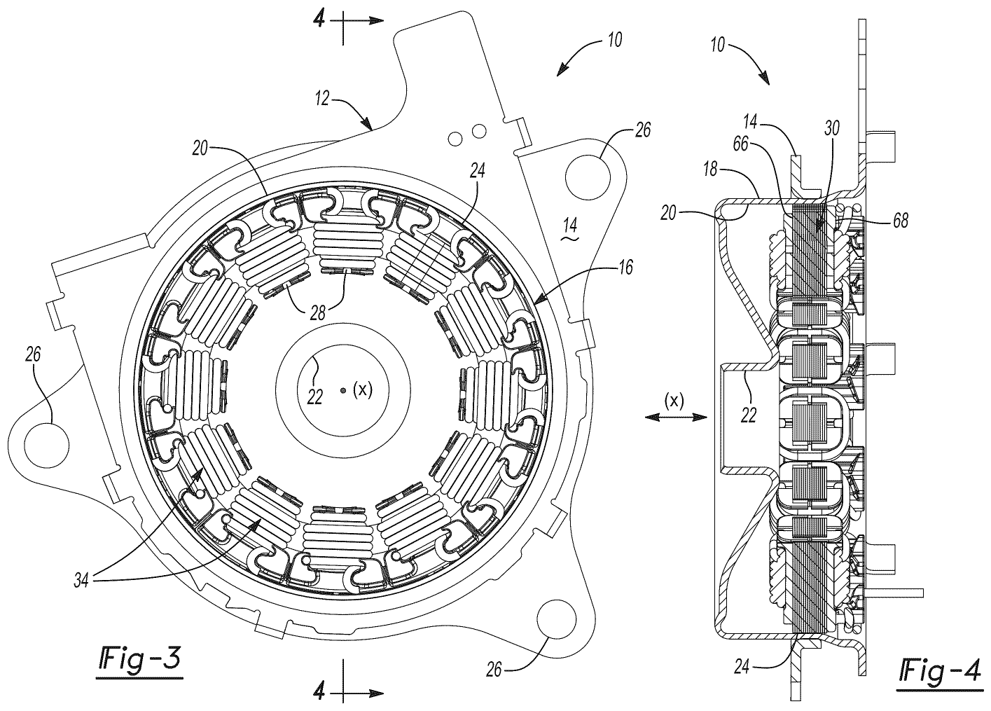

An implementation of a stator assembly 10 used in a rotating electrical machine having tooth insulators is shown in FIGS. 1-5. The stator assembly 10 includes a stator housing 12, a mounting flange 14 coupled to the stator housing 12, and a stator core 16. The stator housing 12 can include an enclosure 18 having an inner diameter 20 sized to receive a rotor shaft (not shown) and an outer diameter 22 that is sized to closely conform to an outer diameter 24 of the stator core 16 so as to create an interference or friction fit between the stator housing 12 and the stator core 16. The enclosure 18 of the stator housing 12 can be closed on one end in between the inner diameter 20 and the outer diameter 22. In one implementation, the stator housing 12 can be stamped from sheet metal using a draw die. The mounting flange 14 can extend radially-outwardly from the outer diameter 24 of the enclosure 18 and can include apertures 26 sized to receive threaded fasteners for mounting the rotating electrical machine.

The stator core 16 can be formed from a ferric material and include a plurality of radially-inwardly-facing stator teeth 28. The quantity of stator teeth 28 can depend on the design of the rotating electrical machine. In the implementation shown, the stator core 16 includes twelve stator teeth 28. The stator teeth 28 extend radially-inwardly from a stator back iron 30 that, when assembled with the other components of the rotating electrical machine, forms a substantially circular shape. In some implementations, the stator core 16 can be a “rolled stator” such that in an initial state the stator core 16 exists in a linearly-extending form thereby increasing the amount of space in between adjacent stator teeth 30. Tooth insulators 32 can be mechanically deformed to slide over each stator tooth 28 such that when the force deforming the tooth insulators 32 is removed, the tooth insulator 32 can hold onto the stator tooth 28 preventing relative movement between the tooth insulator 32 and the stator tooth 28. This will be discussed below in more detail.

After the tooth insulators 32 have been installed on each of the stator teeth 30, stator windings 34 can be wound around the tooth insulators 32 over the stator teeth 30. The stator windings 34 can be formed from metal wire, such as copper, and wound around the stator teeth 30 using any one of a variety of techniques or machines. For example, the stator windings 34 can be concentrated windings wound around each stator tooth 28 using a needle winding machine. Once the stator windings 34 have been wound around the tooth insulators 32 (and therefore the stator teeth 30), the stator core 16 can be rolled from its linear form into a substantially circular form so that it can be pressed into the enclosure 18 of the stator housing 12. The tooth insulators 32 can include planar portions 33 on an exterior radial surface that can bear sufficient load to press the stator core 16 into the stator housing 12. The stator core 16 can be concentrically received by the stator housing 12 such that the stator core 16 can be press-fit to move axially along an axis of shaft rotation (x) to create an interference fit between an inner surface or diameter 20 of the enclosure 18 of the stator housing 12 and the stator core 16. Other implementations of stator cores are possible. For example, the stator core can initially exist in a rigid and substantially circular shape such that the tooth insulators can be added to the stator teeth while the stator core is in this substantially-circular shape and then the stator windings can be wound around the tooth insulators. The rigid stator core assembled with tooth insulators and stator windings around the tooth insulators can then be mechanically pressed or forced into the stator housing.

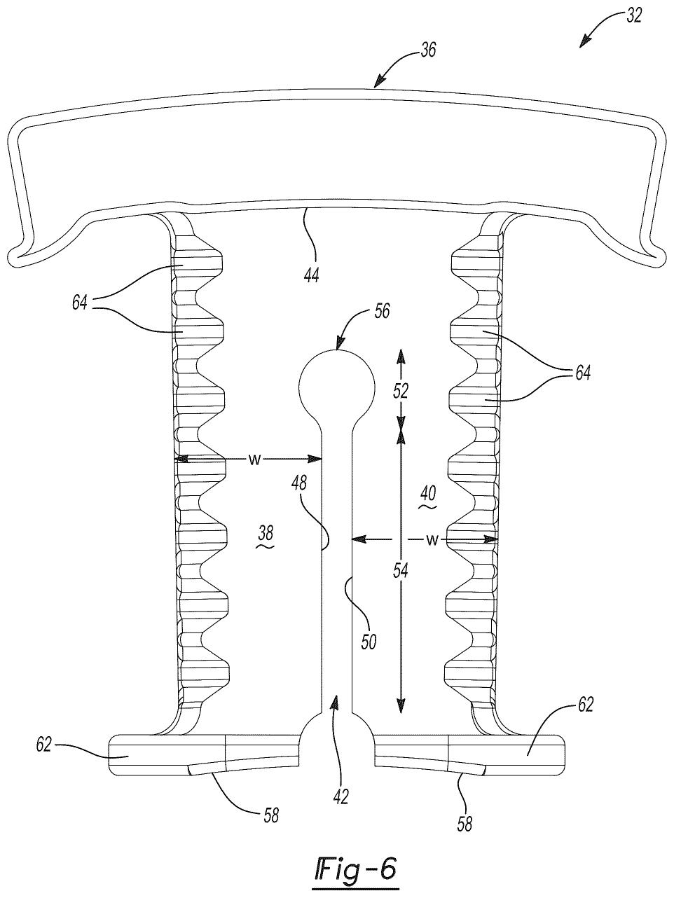

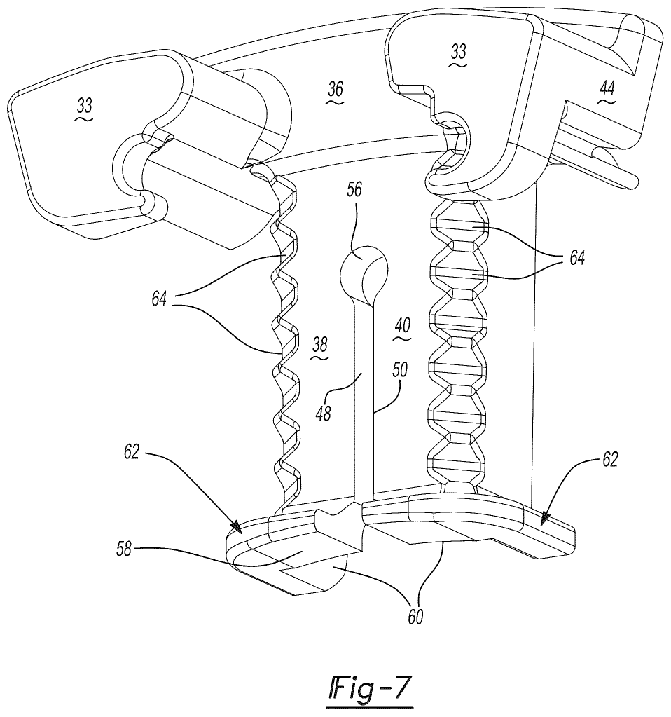

Turning to FIGS. 6 and 7, an implementation of the tooth insulator 32 is shown. The tooth insulator 32 includes a body 36, a first elongated leg 38, a second elongated leg 40, and a deformable slot 42 existing in between, and defined by, the first elongated leg 38 and the second elongated leg 40. The body 36 can have an arcuate shape that closely matches the shape of an outer surface of the stator core 16. The body 36 can include a support surface 44 that faces radially inwardly to support the tooth insulator 32 as it rests on the stator core 16. The first elongated leg 38 and the second elongated leg 40 extend radially-inwardly away from the body 36 and towards an axis of motor rotation (x). The shape of the first elongated leg 38 and the second elongated leg 40 can define the deformable slot 42 positioned in between the first elongated leg 38 and the second elongated leg 40. The first elongated leg 38 and the second elongated leg 40 are designed to have sufficient elasticity to move apart from each other in response to an applied separating force as the tooth insulator 32 is installed over the outer surface of the stator tooth 28 at its radial face 46, yet firmly grip the stator tooth 28 once the first elongated leg 38 and the second elongated leg 40 abut the stator tooth 28 and the separating force is withdrawn.

A number of variables can be adjusted to control the amount of separating force used to move the first elongated leg 38 apart from the second elongated leg 40. For example, the thickness of the first elongated leg 38 and the second elongated leg 40 measured along the axial direction of the axis of motor rotation (x) can be increased to increase the amount of separating force per unit distance or the thickness can be decreased to decrease the amount of separating force per unit distance. This control of thickness can also control the amount of gripping force exerted by the tooth insulators 32 while they are in situ, installed and holding on to a stator tooth 28. Also, the shape of the deformable slot 42 can be altered to control the amount of separating force and force gripping the stator tooth 28 once installed. For example, as the first elongated leg 38 and the second elongated leg 40 extend away from the base 36, the width of each can vary.

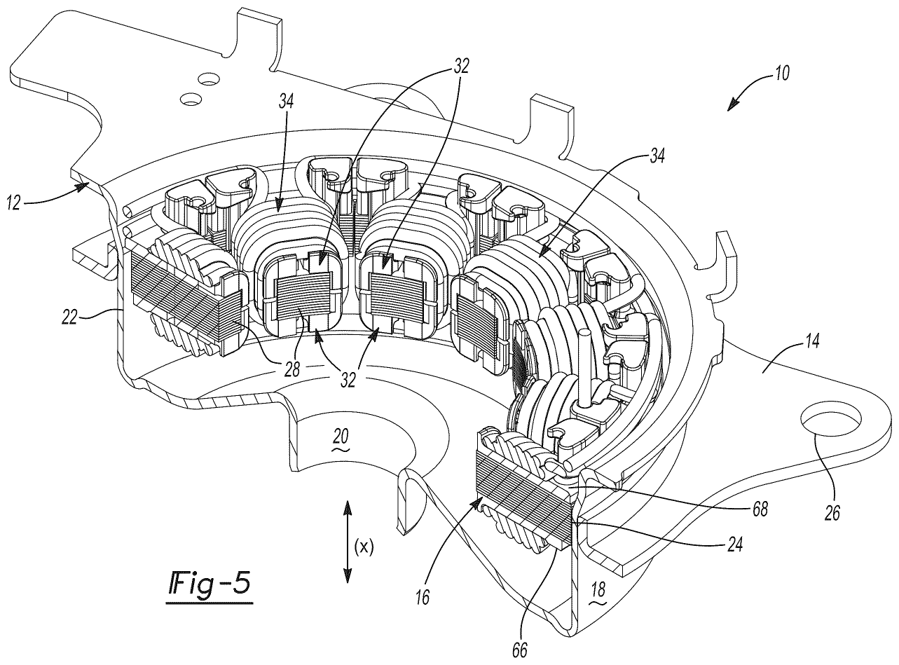

One implementation of the first elongated leg 38, the second elongated leg 40, and the deformable slot. 42 is shown in FIG. 5. The deformable slot 42 can be defined by the width (w) of the first elongated leg 38 and the second elongated leg 40 as well as an inner surface 48 of the first elongated leg 38 and and inner surface 50 the second elongated leg 40. As the first elongated leg 38 and the second elongated leg 40 extend away from the base 36, along a first axial length 52 the width (w) of the first elongated leg 38 and the width (w) of the second elongated leg 40 can continuously vary, forming a circular shape 56 in the deformable slot 56. Moving toward a distal end 58 of the first elongated leg 38 and the second elongated leg 40, along a second axial length 54, the width (w) of the first elongated leg 38 and the width (w) of the second elongated leg 40 can remain constant. A tooth-gripping surface 60, shaped to conform to an outer surface of the tooth 28, is formed at the distal end 58 of the first elongated leg 38 as well as at the distal end 54 of the second elongated leg 40. The distal end 58 of each leg 38, 40 can also include a flared end 62 to help guide the stator windings 34 of stator wire around the tooth insulator 32. The first elongated leg 38 and the second elongated leg 40 can include shaped relief features 64 extending at least partially along the legs 38, 40 in between the base 36 and the distal end 58. The relief features 64 can be radiused surfaces having shapes that closely conform to the substantially circular cross-section of many wires that could be used to implement the stator windings 34.

In another implementation of a tooth insulator 32, the width (w) of the first elongated leg 38 and the width (w) of the second elongated leg 40 can exist at a maxima at the base 36 and then the width (w) can gradually decrease toward the distal end 58 of the first elongated leg 38 and the distal end 58 of the second elongated leg 40. The width and/or shape of the inner surface 48 of the first elongated leg 38 and an inner surface 50 of the second elongated leg 40 can define the shape of the deformable slot 42. As the first elongated leg 38 and the second elongated leg 40 are spaced apart from each other, the contours or shape of the deformable slot 42 can change as the tooth insulator 32 flexes to permit installation and then contracts to grip or hold onto the stator tooth 32.

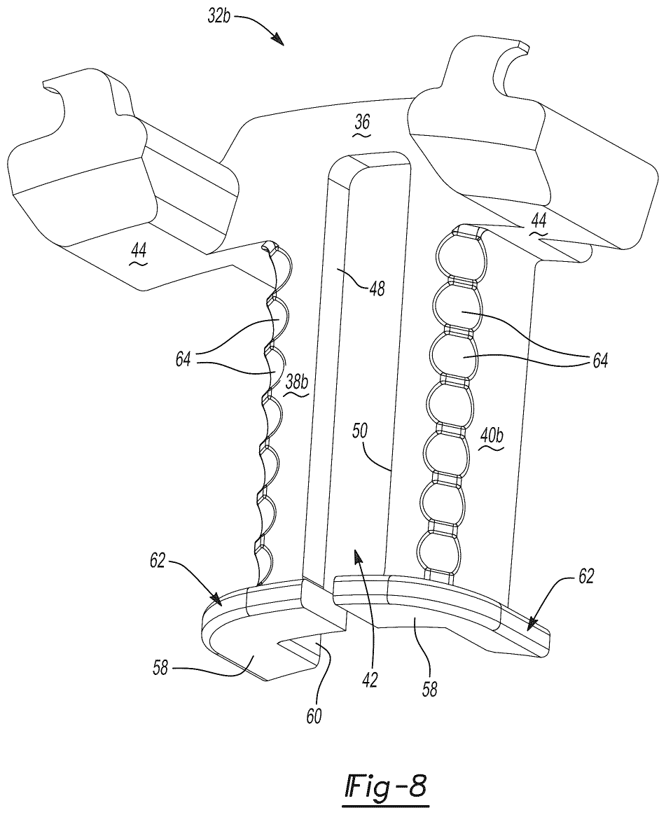

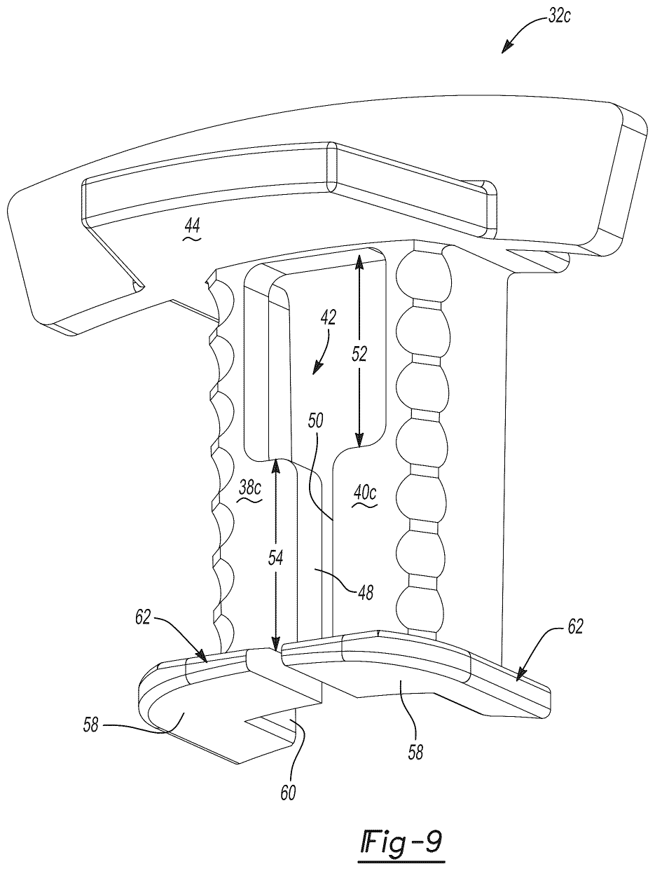

Another implementation of a tooth insulator 32b is shown in FIG. 8. The tooth insulator 32b is shown having the first elongated leg 38b and the second elongated leg 40b extending away from the base 36 such that the width (w) of the first elongated leg 38b and the width (w) of the second elongated leg 40b are substantially constant from the base 36 to the distal end 58. A stator wire guide 70 can extend from the body 36 to help guide stator windings 16 within the stator housing 16. Yet another implementation of a tooth insulator 32c is shown in FIG. 9. The width (w) of the first elongated leg 38c and the second elongated leg 40c along the first axial length 52 is one value and the width (w) along the along a second axial length 54.

The tooth insulator 32 can be shaped to couple with the stator tooth 28 on one radial face 66 of the stator core 16 such that the first elongated leg 38 and the second elongated leg 40 can abut the radial face 66 of the stator core 16 along the stator tooth 28. Another tooth insulator 32 can couple to the stator tooth 28 on an opposite radial face 68 of the stator core 16 so that separate tooth insulators 32 couple to the stator tooth 28 on opposite radial sides 66, 68 of the stator tooth 28. The tooth insulator 32 can be formed from an electrically-insulating material, such as glass filled thermoplastic resin. However, other materials are possible, such as thermoplastic resin, thermoset resin, elastomer, or a fiber composite. In one implementation, the material forming the tooth insulator 32 can initially exist in a liquid form that is inserted in a mold, and allowed to cool. Once cooled, the tooth insulator 32 can be removed from the mold and coupled with a stator tooth 28. As noted above, while the embodiments described here involve stator assemblies and stator teeth, the tooth insulators described here can also be used be used in rotor assemblies having rotor teeth wound with coil wire.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A tooth insulator for use in a rotating electrical machine, comprising:
a body, shaped to conform to an outer surface of a tooth;
a first elongated leg, extending away from the body;
a second elongated leg, extending away from the body; and
a deformable slot positioned between the first elongated leg and the second elongated leg, wherein the deformable slot permits temporary displacement of the first elongated leg relative to the second elongated leg to fit over an outer surface of the tooth and force exerted by the first elongated leg and the second elongated leg on the outer surface of the tooth when in situ.

2. The tooth insulator recited in claim 1, further comprising at least one planar portion capable of receiving force to press the tooth insulator into a stator housing.

3. The tooth insulator recited in claim 1, further comprising a collar positioned at a distal end of the first elongated leg and the second elongated leg configured to abut a stator winding.

4. The tooth insulator recited in claim 1, wherein the deformable slot increases in size between the first elongated leg and the second elongated leg moving away from the body to a distal end of the first elongated leg and a distal end of the second elongated leg.

5. The tooth insulator recited in claim 1, wherein the deformable slot maintains a constant distance between the first elongated leg and the second elongated leg moving away from the body to a distal end of the first elongated leg and a distal end of the second elongated leg.

6. The tooth insulator recited in claim 1, wherein the deformable slot includes a variable distance between the first elongated leg and the second elongated leg along a first axial length of the first elongated leg and the second elongated leg, and a constant distance between the first elongated leg and the second elongated leg along a second axial length of the first elongated leg and the second elongated leg.

7. The tooth insulator recited in claim 1, wherein the first elongated leg and the second elongated leg include a plurality of radiuses relief features, extending along an outer surface of the first elongated leg and an outer surface of the second elongated leg, shaped to accommodate an outer surface shape of a winding.

8. The tooth insulator recited in claim 1, wherein an outer surface of the body is configured to receive a portion of a winding.

9. The tooth insulator recited in claim 1, wherein a distal end of the first elongated leg includes a tooth-gripping surface shaped to conform to the outer surface of the tooth and the second elongated leg includes a tooth-gripping surface shaped to conform to the outer surface of the tooth.

10. The tooth insulator recited in claim 1, wherein the tooth is attached to a stator core.

11. A tooth insulator for use in a rotating electrical machine, comprising:
a body, shaped to conform to an outer surface of a stator tooth;
a first elongated leg, extending away from the body, having a tooth-gripping surface configured to abut an outer surface of the stator tooth;
a second elongated leg, extending away from the body, having a tooth-gripping surface configured to abut the outer surface of the stator tooth; and
a deformable slot positioned between the first elongated leg and the second elongated leg, wherein the first elongated leg is displaceable relative to the second elongated leg to fit over an outer surface of the stator tooth, and the first elongated leg and the second elongated leg press against the outer surface of the stator tooth in a default position.

12. The tooth insulator recited in claim 11, further comprising at least one planar portion capable of receiving force to press the tooth insulator into a stator housing.

13. The tooth insulator recited in claim 11, further comprising a collar positioned at a distal end of the first elongated leg and the second elongated leg configured to abut a stator winding.

14. The tooth insulator recited in claim 11, wherein the deformable slot increases in size between the first elongated leg and the second elongated leg moving away from the body to a distal end of the first elongated leg and a distal end of the second elongated leg.

15. The tooth insulator recited in claim 11, wherein the deformable slot maintains a constant distance between the first elongated leg and the second elongated leg moving away from the body to a distal end of the first elongated leg and a distal end of the second elongated leg.

16. The tooth insulator recited in claim 11, wherein the deformable slot includes a variable distance between the first elongated leg and the second elongated leg along a first axial length of the first elongated leg and the second elongated leg, and a constant distance between the first elongated leg and the second elongated leg along a second axial length of the first elongated leg and the second elongated leg.

17. The tooth insulator recited in claim 11, wherein the first elongated leg and the second elongated leg include a plurality of radiused relief features, extending along an outer surface of the first elongated leg and an outer surface of the second elongated leg, shaped to accommodate an outer surface shape of a winding.

18. The tooth insulator recited in claim 11, wherein an outer surface of the body is configured to receive a portion of a winding.
